(19) United States
(12) Patent Application Publication
(10) Pub. No.: US 2008/0031470 A1
(43) Pub. Date: Feb. 7, 2008

(54) REMOTE SPEAKER CONTROLLER WITH MICROPHONE

(75) Inventor: Anders ANGELHAG, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/469,832

(22) Filed: Sep. 1, 2006

Related U.S. Application Data
(60) Provisional application No. 60/821,290, filed on Aug. 3, 2006.

(51) Int. Cl. H04B 1/00

(52) U.S. Cl. 381/77

(57) ABSTRACT

A system includes a communication device, an external speaker and a remote control device. The external speaker connects to the communication device and converts audio signals received from the communication device into audible sound. The remote control device includes a microphone and controls operation of the external speaker via control signals transmitted over an air interface. The remote control device further sends audio signals received from the microphone to the external speaker via the air interface. The external speaker further sends the audio signals to the communication device.

### CROSS REFERENCE TO RELATED APPLICATION

The instant application claims priority from provisional application No. 60/821,290, filed Aug. 3, 2006, the disclosure of which is incorporated by reference herein in its entirety.

### TECHNICAL FIELD OF THE INVENTION

Implementations described herein relate generally to mobile communication devices and, more particularly, to external speakers used in conjunction with mobile communication devices.

### BACKGROUND

Media players, that play digital music and/or video files, have recently surged in popularity among the consumer electronics purchasing public. Widespread commercial availability of such players has followed their popularity. MPEG layer 3 (MP3) players are one example of a media player that plays audio digital files (e.g., MP3 files). In light of the commercial success of stand-alone digital media players, mobile phone manufacturers have introduced built-in media player functionality into their mobiles phones. Such mobile phones may download and store digital media files, such as MP3 digital audio files, that may be played back by the mobile phone itself, without having to use an external media player. To obtain louder and high quality sound from a mobile phone with media player capability, external speaker systems have been introduced that can receive and amplify audio from the mobile phone. These external speaker systems plug into existing “hands-free” connector plugs on the mobile phone, which normally connect to headsets that include an ear “bud” and microphone for hands free use by the mobile phone user.

### SUMMARY

According to one aspect, a device may include an input device configured to receive user instructions related to controlling operation of an audio speaker and a microphone configured to receive audio input. The device may further include one or more transmitters configured to transmit the user instructions to the audio speaker via an air interface and transmit the received audio input to the audio speaker via the air interface for transmission to a mobile communication device.

Additionally, the device may include a controller configured to receive the user instructions from the input device and initiate the transmission of the user instructions to the audio speaker via the air interface.

Additionally, the controller may be configured to receive the audio input and initiate the transmission of the audio input to the audio speaker,

Additionally, the audio speaker may include a transducer configured to convert electrical signals to audible sound.

Additionally, the one or more transmitters may include an infrared transmitter, where the infrared transmitter transmits the user instructions to the audio speaker.

Additionally, the one or more transmitters may include a radio frequency transmitter, where the radio frequency transmitter transmits the received audio input to the audio speaker.

Additionally, the mobile communication device may include a radiotelephone device.

According to another aspect, a system may include a communication device and an external speaker connected to the communication device and configured to convert audio signals received from the communication device into audible sound. The system may further include a remote control device that includes a microphone and configured to control operation of the external speaker via control signals transmitted over an air interface and send audio signals received from the microphone to the external speaker via the air interface, where the external speaker further sends the audio signals to the communication device.

Additionally, the remote control device may include an input unit, where the remote control device controls operation of the external speaker based on user input received via the input unit.

Additionally, the remote control device may transmit the control signals and audio signals to the external speaker over the air interface via one of infrared or radio frequency signals.

Additionally, the communication device may include a radiotelephone.

Additionally, the external speaker may be located remotely from the communication device.

Additionally, the remote control device may be located remotely from the communication device and the external speaker.

According to an additional aspect, an audio device may include one or more receivers configured to receive speaker control signals and audio signals from a remote device via an air interface. The audio device may further include audio output circuitry and at least one speaker configured to convert electrical signals received from an external communication device to audible sound. The audio device may also include a controller configured to adjust operation of the audio device based on the received control signals, and send the audio signals to the external communication device.

Additionally, the communication device may include a radiotelephone.

Additionally, the one or more receivers may include an infrared receiver, where the infrared receiver receives the control signals via the air interface.

Additionally, the one or more receivers may include a radio frequency receiver, where the radio frequency receiver receives the audio signals via the air interface.

According to yet another aspect, a system may include an audio speaker, and a control device that includes a transducer to convert incident sound to audio signals and at least one transmitter to transmit the audio signals to the audio speaker via an air interface. The audio speaker may be configured to convert electrical signals received from a communication device to audible sound, receive the audio signals from the control device via the air interface, and re-transmit the audio signals to the communication device.

Additionally, the control device may further include an input unit to receive input from a user for controlling operation of the audio speaker, where the at least one transmitter furthers transmits control signals to the audio speaker via the air interface based on the user input.

Additionally, the audio speaker may be further configured to receive audio electrical signals from the communication device, and convert the audio electrical signals to audible sound.

According to a further aspect, a device may include means for receiving user instructions related to controlling operation of an external audio speaker and means for transmitting the user instructions to the external audio speaker via an air interface. The device may further include means for receiving audio input and means for transmitting the received audio input to the audio speaker via the air interface for transmission to a mobile communication device.

It should be emphasized that the ten-n ” comprises/comprising” when used in this specification is taken to specify the presence of stated features, integers, steps, components or groups but does not preclude the presence or addition of one or more other features, integers, steps, components or groups thereof.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 illustrates an exemplary system in which aspects of the invention may be implemented;

FIG. 2 illustrates an exemplary system that includes a cellular network;

FIG. 3 illustrates an exemplary mobile station;

FIG. 4 illustrates the use of an external speaker and speaker remote control with a mobile station of FIG. 1 according to an exemplary implementation;

FIG. 5 illustrates an exemplary configuration of the speaker remote control of FIG. 4;

FIG. 6 illustrates an exemplary configuration of the external speaker of FIG. 4; and

FIG. 7 illustrates exemplary interoperation of the speaker remote control, external speaker and mobile station of FIG. 4.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

External audio speakers, which can be used with mobile phones having built-in digital audio players, may support hands free calling by including microphones within the external audio speakers (or into a stand which supports the speaker). Such external speakers may also include remote control devices that permit a user to control the operation of the external speaker (e.g., decrease/increase volume, alter sound quality, speaker balance, etc.). Disposition of a microphone in an external speaker permits the user to participate in a call via the mobile phone by speaking in close proximity to the external speaker. However, as the performance and output power of external audio speakers improves, users who may prefer to listen at a distance from the external speakers may also prefer to engage in a phone call at a distance from the speakers. As the distance from the external speaker with the microphone increases, though, it becomes harder for the microphone to pick up the voice of the user. Therefore, to permit the user to listen to music at a distance from the external speaker, a microphone may be integrated into the remote control that controls the operation of the external speaker, allowing hands free calls via the mobile phone even when the user is a distance from either the mobile phone or the external speaker. Integration of a microphone into the remote control enables the remote control to provide voice input and speaker control input, received from the user, to the external speaker. The speaker control input may control the operation of the speaker, and the voice input may be supplied, via the external speaker, to the mobile phone for voice communication with another party.

### Exemplary System

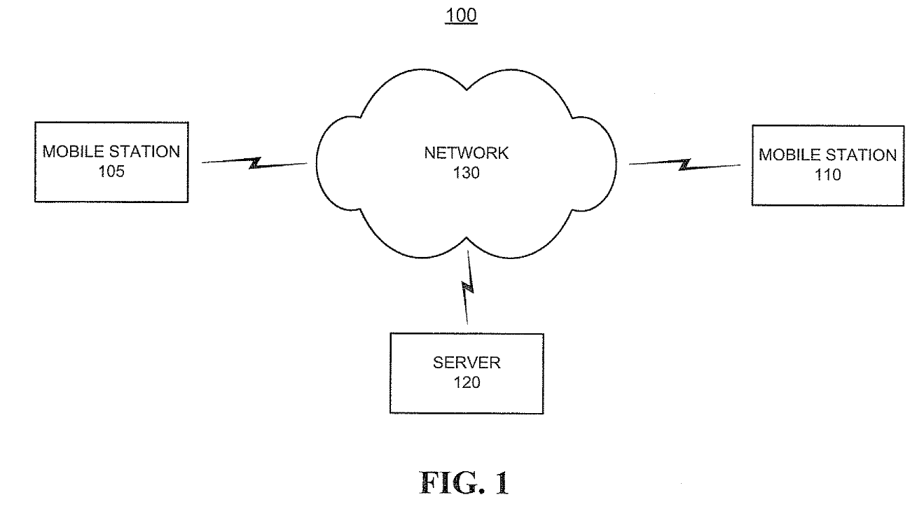

FIG. 1 illustrates an exemplary system 100 in which aspects of the invention may be implemented. System 100 may include a mobile station 105 connected with another mobile station 110 and, possibly, a server 120 via a network 130 using wireless, wired, or optical connection links. Network 130 may include one or more sub-networks of any type, including a local area network (LAN), a wide area network (WAN), a satellite network, a metropolitan area network (MAN), a telephone network, such as the Public Switched Telephone Network (PSTN) or a Public Land Mobile Network (PLM), an intranet, the Internet, or a combination of networks. The PLN(s) may further include a packet-switched sub-network, such as, for example, General Packet Radio Service (GPRS), Cellular Digital Packet Data (CDPD), or Mobile IP sub-network.

Mobile station 105 and mobile station 110 may each include a telephone, cellular radiotelephone, Personal Communications System (PCS) terminal or the like. A PCS terminal may combine a cellular radiotelephone with data processing, facsimile and data communications capabilities. Mobile station 105 and mobile station 110 may each further include a personal digital assistant (PIDA), a conventional laptop and/or palmtop receiver, or another appliance that includes a radiotelephone transceiver, or the like. A PDA may include a radiotelephone, a pager, Internet/intranet access, a web browser, an organizer, calendars and/or a global positioning system (GPS) receiver. Mobile stations 105 and 110 may each further be referred to as a “pervasive computing” devices.

Server 120 includes a server entity that may store media files, such as, for example, digital audio files (e.g., MP3 files), that may be accessed and downloaded by mobile stations 105 and 110 via network 130. Mobile stations 105 and 110 may also exchange media files with one another via network 130.

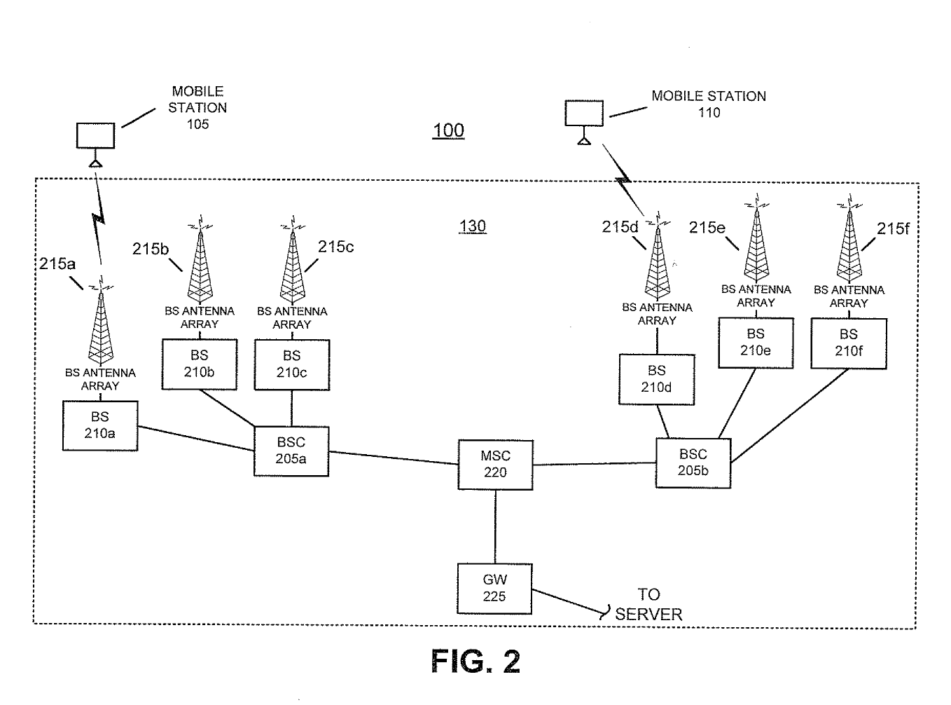

FIG. 2 illustrates one example of system 100 implemented using a cellular network. As shown in FIG. 2, system 100 may include mobile station 105, mobile station 110 and a cellular network 130. Cellular network 130 may include one or more base station controllers (BSCs) 205a-205b, multiple base stations (BSs) 210a-210f, multiple base station antenna arrays 215a-215f, one or more mobile switching centers (MSCs), such as MSC 220, and one or more gateways (GWs), such as GW 225.

Cellular network 130 may include components conventionally used for transmitting data to and from mobile stations 105 and 110. Such components may include base station antenna arrays 215a-215f, which transmit and receive, via appropriate data channels, data from mobile stations within their vicinity. Base stations 210a-210f connect to their respective antenna arrays 215a-215f, and format the data transmitted to, or received from the antenna arrays 215a-215f in accordance with conventional techniques, for communicating with BSCs 205a-205b or a mobile station, such as mobile station 105. Among other functions, BSCs 205a-205b may route received data to either MSC 220 or a base station (e.g., BSs 210a-210c or 210d-210f). MSC 220 routes received data to BSC 205a or 205b. GW 225 may route data received from an external domain (.not shown) (e.g., from server 120 in an external domain) to an appropriate MSC (such as MSC 220), or from an MSC to an appropriate external domain (e.g., to server 120 in an external domain). Server 120 (not shown in FIG. 2) may connect to cellular network 130 via MSC 220 or via another network (e.g., the Internet) connected to GW 225.

### Exemplary Mobile Station

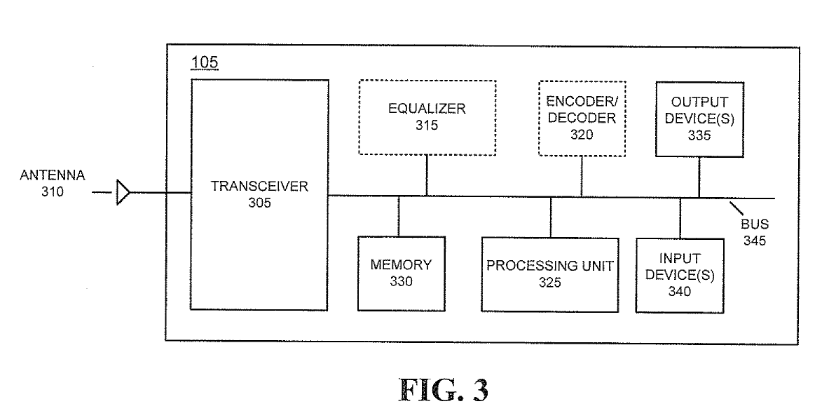

FIG. 3 illustrates an exemplary mobile station 105 consistent with an aspect of the invention. Mobile station 110 may be similarly configured. Mobile station 105 may include a transceiver 305, an antenna 310, an optional equalizer 315, an optional encoder/decoder 320, a processing unit 325, a memory 330, an output device(s) 335, an input device(s) 340, and a bus 345.

Transceiver 305 may include transceiver circuitry well known to one skilled in the art for transmitting and/or receiving symbol sequences in a network, such as network 130, via antenna 310. Transceiver 305 may include, for example, a conventional RAKE receiver. Transceiver 305 may further include mechanisms for estimating the signal-to-interference ratio (SIR) of received symbol sequences. Transceiver 305 may additionally include mechanisms for estimating the propagation channel Doppler frequency. Equalizer 315 may store and implement Viterbi trellises for estimating received symbol sequences using, for example, a maximum likelihood sequence estimation technique. Equalizer 315 may additionally include mechanisms for performing channel estimation.

Encoder/decoder 320 may include circuitry for decoding and/or encoding received or transmitted symbol sequences. Processing unit 325 may perform all data processing functions for inputting, outputting, and processing of data including data buffering and terminal control functions, such as call processing control, user interface control, or the like. Memory 330 provides permanent, semi-permanent, or temporary working storage of data and instructions for use by processing unit 325 in performing processing functions. Memory 330 may include large-capacity storage devices, such as a magnetic and/or optical recording medium and its corresponding drive.

Output device(s) 335 may include mechanisms for outputting data in video, audio, and/or hard copy format. Input device(s) 340 permit entry of data into mobile terminal 105 and may include a user interface and a microphone (not shown). The microphone can include mechanisms for converting auditory input into electrical signals. Bus 345 interconnects the various components of mobile terminal 105 to permit the components to communicate with one another. The configuration of components of mobile terminal 105 illustrated in FIG. 3 is for illustrative purposes only. One skilled in the art will recognize that other configurations may be implemented.

### Exemplary Speaker Remote Control with Microphone

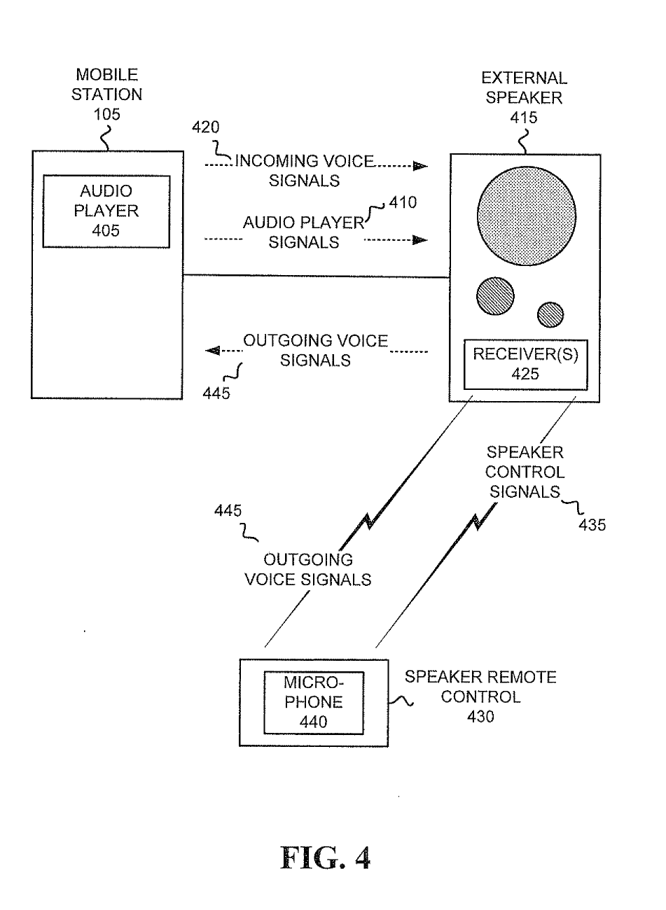

FIG. 4 illustrates the use of an external speaker and speaker remote control with a mobile station 105/110 according to an exemplary implementation. As shown, mobile station 105 may include an audio player 405 that may provide audio player signals 410 to an external speaker 415 via a hands free connection provided on the mobile station (e.g., an input/output plug that permits hands free headsets or external speakers to be connected to mobile station 105). Audio player 405 may play digital media, such as, for example, MP3 audio files, and may provide the audio player signals 410 to external speaker 415 for conversion into audible sound. Mobile station 105, when engaged in a call with mobile station 110 via network 130 (not shown), may additionally supply incoming voice signals 420 received from mobile station 110 to external speaker 415. In some implementations, when incoming voice signals 420 are received from mobile station 110, mobile station 105 may preempt any audio files being played on audio player 405 and only supply incoming voice signals 420 to external speaker 415 (e.g., the audio file is put “on hold” until completion of the call between mobile station 105 and mobile station 110). External speaker 415 may include a receiver(s) 425 for receiving speaker control signals 435 and outgoing voice signals 445 (described below).

As further shown in FIG. 4, a speaker remote control 430 may control the operation of external speaker 415 via speaker control signals 435. Speaker control signals 435 may be generated by user instructions (edg., volume increase/decrease, treble increase/decrease, bass increase/decrease, etc.) received via a user input (not shown) at speaker remote control 430. Speaker remote control 430 may further include a microphone 440 that may include a transducer for converting incident sound into electrical signals. Microphone 440 may convert voice input, from the user using speaker remote control 430, into outgoing voice signals 445. Speaker remote control 430 may transmit outgoing voice signals 445 to receiver(s) 425 of external speaker 415 over an air interface. External speaker 415 may supply outgoing voice signals 445 to mobile station 105 for subsequent transmission to mobile station 110 via network 130 (not shown).

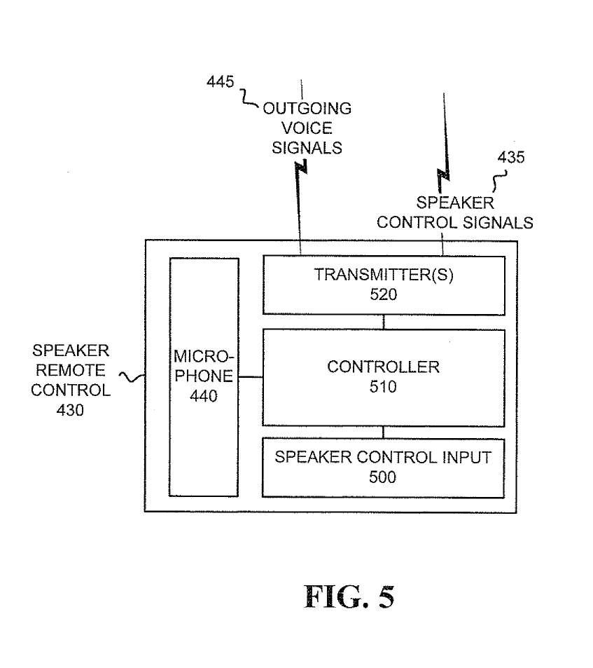

FIG. 5 illustrates a configuration of speaker remote control 430 according to an exemplary implementation. Speaker remote control 430 may include a microphone 440, a speaker control input unit 500, a controller 510 and a transmitter(s) 520. Microphone 440 may include a transducer that converts incident sound (e.g., voice) to an electrical signal that may be transmitted by transmitter(s) 520 as outgoing voice signals 445. In one implementation, transmitter(s) 520 may include a radio frequency transmitter that may transmit outgoing voice signals 445 as radio frequency signals over an air interface to external speaker 415. Speaker control input 500 may include any type of user interface that allows the user to provide input for controlling the operation of external speaker 415. Controller 5 10 may include any type of processing device (e.g., a microprocessor) or processing logic that may be configured to control the operation of speaker remote control 430. Controller 5 10 may receive user inputs from speaker control input 500 and instruct transmitter(s) 520 to transmit corresponding speaker control signals 435. In one implementation, transmitter(s) 520 may include an infrared transmitter that may transmit speaker control signals 435 as infrared signals over the air interface to external speaker 415. Controller 510 may further receive audio signals from microphone 440 and instruct transmitter(s) 520 to transmit the audio signals as outgoing voice signals 445 to external speaker 415.

### Exemplary External Speaker

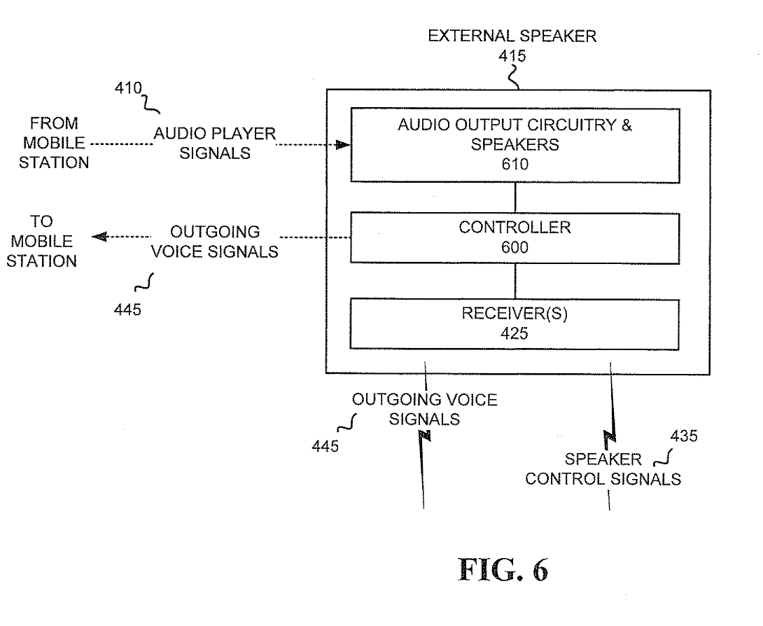

FIG. 6 illustrates a configuration of external speaker 415 according to an exemplary implementation. External speaker 415 may include a receiver(s) 425, a controller 600 and audio output circuitry and speakers 610. Receiver(s) 425 may receive outgoing voice signals 445 and speaker control signals 435 over the air interface from speaker remote control 430. In one implementation, receiver(s) 420 may include a radio frequency receiver for receiving outgoing voice signals 445 as radio frequency signals over the air interface. In another implementation, receiver(s) 425 may include an infrared receiver for receiving speaker control signals 435 as infrared signals over the air interface. Controller 600 may, based on the received speaker control signals 435, control the operation of external speaker 415 (e.g., increase/decrease volume, increase/decrease treble, increase/decrease bass, etc.). Controller 600 may also send the received outgoing voice signals 445 on to mobile station 105 via the hands-free connection between external speaker 415 and mobile station 105. Audio output circuitry & speakers 610 may convert audio player signals 410 received from mobile station 105 via the hands-free connection to audible sound based on the received speaker control signals 435.

### Exemplary System Interoperation

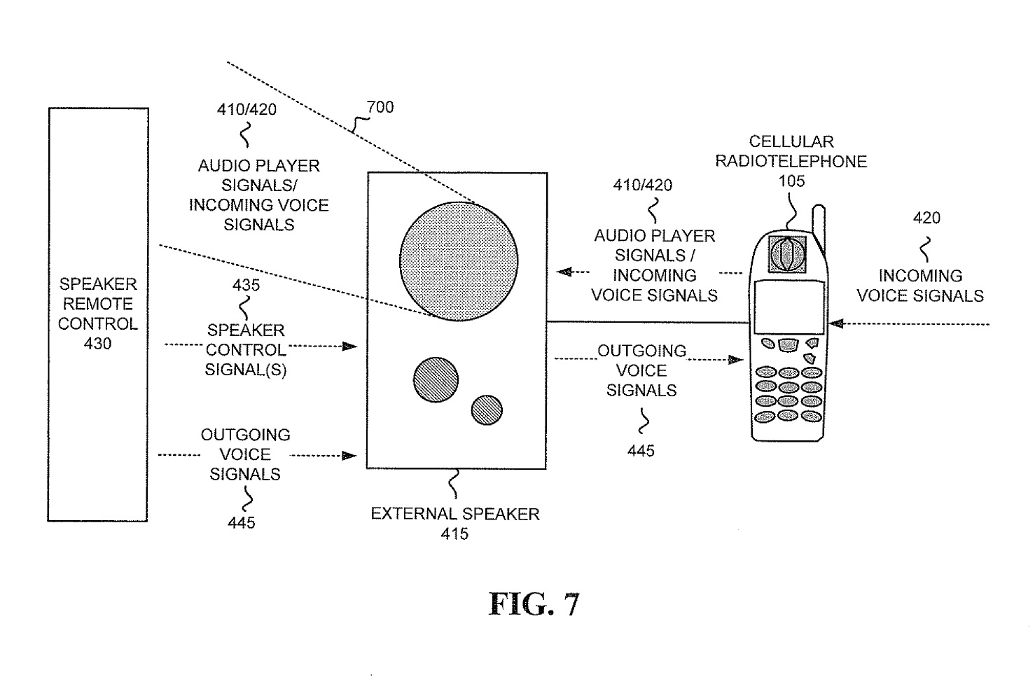

FIG. 7 illustrates interoperation of the speaker remote control 430, external speaker 415 and mobile station 10s according to an exemplary implementation. As shown in FIG. 7, mobile station 105 may include a cellular radiotelephone that operates as an audio player to produce audio player signals 410 that may be sent via the hands-free connection between radiotelephone 105 and external speaker 415. External speaker 415 may convert the audio player signals 410 into audible sound 700 that can be listened to by a user. The user, using speaker remote control 430, may control the operation of external speaker 415 via speaker control signals 435. While listening to audio played on cellular radiotelephone 105, a call may be received by radiotelephone 105 via network 130 (not shown). Radiotelephone 105 may receive the incoming voice signals 420 from the other party to the call and may forward incoming voice signals 420 for the call to external speaker 415 via the hands free connection. External speaker 415 may convert the incoming voice signals 420 into audible sound 700 that can be listened to by the user. The user may listen to the audible sound 700 associated with the incoming voice signals 420 and talk into the microphone (not shown) of speaker remote control 430 to provide outgoing voice signals 445 to external speaker 415 via infrared or radio frequency signals over the air interface. External speaker 445 may send the outgoing voice signals 445 to radiotelephone 105 via the hands free connection for subsequent transmission to the other party at mobile station 110 via network 130 (not shown).

### Conclusion

The foregoing description of implementations provides illustration and description, but is not intended to be exhaustive or to limit the invention to the precise form disclosed. Modifications and variations are possible in light of the above teachings, or may be acquired from practice of the invention. While implementations have been described as locating a microphone in the external speaker remote control, in other implementations, a portable Bluetooth hands free device (e.g., a headset) may alternatively be used in place of the microphone described herein. In such implementations, the Bluetooth headset may be used for outgoing voice and, possibly, for speaker remote control, and the external speaker may be used for incoming voice. Implementations have been described herein with respect to a microphone being disposed in a speaker remote control device. However, in other implementations, the microphone could be disposed in other types of devices, such as, for example, a karaoke device, a voice control device, etc.

One skilled in the art will recognize that implementations described herein may be applied to any wired or wireless system utilizing any type of multi-access scheme, such as TDMA, CDMA or FDMA. It should be further understood that implementations described herein may be utilized in hybrid systems that are combinations of two or more of the above multi-access schemes. In addition, a communication device, in accordance implementations described herein, may be designed to communicate with, for example, a base station transceiver using any standard based on GSM, TDMA, CDMA, FDMA, a hybrid of such standards or any other standard.

Aspects of the invention may also be implemented in methods and/or computer program products. Accordingly, the invention may be embodied in hardware and/or in software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with principles of the invention is not limiting of the invention. Thus, the operation and behavior of the aspects were described without reference to the specific software code-it being understood that one of ordinary skill in the art would be able to design software and control hardware to implement the aspects based on the description herein.

Furthermore, certain portions of the invention may be implemented as “logic” that performs one or more functions. This logic may include hardware, such as an application specific integrated circuit or field programmable gate array, software, or a combination of hardware and software.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A device, comprising:
an input device configured to receive user instructions related to controlling operation of an audio speaker;
a microphone configured to receive audio input; and
one or more transmitters configured to:
transmit the user instructions to the audio speaker via an air interface, and
transmit the received audio input to the audio speaker via the air interface for transmission to a mobile communication device.

2. The device of claim 1>further comprising:
a controller configured to receive the user instructions from the input device and initiate the transmission of the user instructions to the audio speaker via the air interface.

3. The device of claim 2, wherein the controller is further configured to receive the audio input and initiate the transmission of the audio input to the audio speaker.

4. The device of claim 1, wherein the audio speaker comprises a transducer configured to convert electrical signals to audible sound.

5. The device of claim 1, wherein the one or more transmitters includes an infrared transmitter and wherein the infrared transmitter transmits the user instructions to the audio speaker.

6. The device of claim 1, wherein the one or more transmitters includes a radio frequency transmitter and where the radio frequency transmitter transmits the received audio input to the audio speaker.

7. The device of claim 1, wherein the mobile communication device comprises a radiotelephone device.

8. A system, comprising:
a communication device;
an external speaker connected to the communication device and configured to convert audio signals received from the communication device into audible sound; and
a remote control device that includes a microphone and configured to:
control operation of the external speaker via control signals transmitted over an air interface, and
send audio signals received from the microphone to the external speaker via the air interface,
wherein the external speaker further sends the audio signals to the communication device.

9. The system of claim 8, wherein the remote control device includes an input unit and wherein the remote control device controls operation of the external speaker based on user input received via the input unit.

10. The system of claim 8, wherein the remote control device transmits the control signals and audio signals to the external speaker over the air interface via one of infrared or radio frequency signals.

11. The system of claim 8, wherein the communication device comprises a radiotelephone.

12. The system of claim 8, wherein the external speaker is located remotely from the communication device.

13. The system of claim 12, wherein the remote control device is located remotely from the communication device and the external speaker.

14. An audio device, comprising:
one or more receivers configured to receive speaker control signals and audio signals from a remote device via an air interface;
audio output circuitry and at least one speaker configured to convert electrical signals received from an external communication device to audible sound; and
a controller configured to:
adjust operation of the audio device based on the received control signals, and
send the audio signals to the external communication device.

15. The audio device of claim 14, wherein the communication device comprises a radiotelephone.

16. The audio device of claim 14, wherein the one or more receivers include an infrared receiver and wherein the infrared receiver receives the control signals via the air interface.

17. The audio device of claim 14, wherein the one or more receivers include a radio frequency receiver and wherein the radio frequency receiver receives the audio signals via the air interface.

18. An system, comprising:
an audio speaker; and
a control device comprising:
a transducer to convert incident sound to audio signals, and
at least one transmitter to transmit the audio signals to the audio speaker via an air interface,
wherein the audio speaker is configured to:
convert electrical signals received from a communication device to audible sound,
receive the audio signals from the control device via the air interface, and
re-transmit the audio signals to the communication device.

19. The system of claim 18, wherein the control device further comprises:
an input unit to receive input from a user for controlling operation of the audio speaker,
wherein the at least one transmitter furthers transmits control signals to the audio speaker via the air interface based on the user input.

20. The system of claim 18, wherein the audio speaker is further configured to:
receive audio electrical signals from the communication device, and
convert the audio electrical signals to audible sound.

21. A device, comprising:
means for receiving user instructions related to controlling operation of an external audio speaker;
means for transmitting the user instructions to the external audio speaker via an air interface;
means for receiving audio input; and
means for transmitting the received audio input to the audio speaker via the air interface for transmission to a mobile communication device.
